(19) United States
(12) Patent Application Publication
(10) Pub. No.: US 2017/0315616 A1
(43) Pub. Date: Nov. 2, 2017

(54) VIBRATING MOUSE PROVIDING REAL TIME HAPTIC FEEDBACK

(71) Applicants: Jung-Hoon KIM, Daegu (KR); Jae-Seong PARK, Seoul (KR)

(72) Inventors: Jung-Hoon KIM, Daegu (KR); Jae-Seong PARK, Seoul (KR)

(21) Appl. No.: 15/521,529

(22) PCT Filed: Jul. 22, 2015
(86) PCT No.: PCT/KR2015/007642

§ 371 Date: Apr. 24, 2017

(30) Foreign Application Priority Data
Dec. 1, 2014 (KR) 10-2014-0169880
Jan. 12, 2015 (KR) 10-2015-0004291

(51) Int. Cl. G06F 3/01; G06F 3/0354

(52) U.S. Cl. CPC G06F 3/016; G06F 3/03543

(57) ABSTRACT

The present invention relates to a vibrating mouse providing a haptic feedback corresponding to visual information, the vibrating mouse in which: a piezoelectric element layer, which has a piezoelectric effect, and a central electrode plate are integrally formed so as to constitute a piezoelectric vibration body; both ends of the piezoelectric vibration body are fixed so as to generate vibration by vertical bending displacement; one or more actuators, to which a weight piece for increasing vibration in the piezoelectric vibration body is attached and fixed, are provided inside a body of a vibrating mouse so as to respond, with varying vibrations in a high frequency band, thereby transmitting various amounts of vibration corresponding to the visual information, by means of a quick vibration response, and transmit visual information and vibratory tactility with a quick response speed such that the user can have a visual and tactile experience simultaneously.

### TECHNICAL FIELD

The present invention relates to a vibrating mouse, and more particularly to a vibrating mouse that is capable of providing a signal output from an electronic device for the user through a real-time haptic feedback.

### BACKGROUND ART

Recently, with the development of a technology for implementing virtual reality, the user's demand for more specific and realistic information through virtual reality has increased. One of the technologies that have been developed to satisfy this demand is a haptic technology, which provides a haptic feedback and force. The haptic technology is not only applied to a simple alarm function using a vibrating motor but also to various fields including, for example, medical simulators or game devices.

In the future, it is expected that a haptic device will be added to computing apparatuses as standard together with other output devices such as a monitor or a speaker. This is because the installation of a haptic device to a portable electronic device entails advantages of providing a better tactile recognition for the user and of improving interoperability with an IT device.

In addition to a function as a simple input device that is used to easily interface with a computer, the function of a mouse as an output device is being extended to enable the user to enjoy a variety of programs executed by the computer.

Specifically, there has been recently developed a vibrating mouse, in which vibration patterns are predetermined in accordance with sounds output from a computer in order to enable the user to feel vibration of a given pattern when a predetermined condition is satisfied while the user is gaming.

A conventional vibrating mouse, which employs a vibrating motor as a vibration generation means using an eccentric weight, generates vibration due to shaking generated by eccentric rotation of the motor, but has a shortcoming in that a response speed thereof is not sufficient to enable the user to feel synchronized vibration because of a vibration delay time from the transmission of a signal to the rotation of the motor at a predetermined speed or higher.

Also, in the case of a linear motor, which transmits vibration through linear motion, the response time is not sufficient to enable the user to feel synchronized vibration.

Further, various vibration patterns, for example, a strong vibration or a micro vibration, must be controlled at an extremely high response speed in order to properly achieve a haptic function; however, a vibrating motor using eccentric rotation or a linear motor using a linear motion remains at the level of providing a simple vibration alarm function.

The response time that enables the human to feel vibration in synchronization with visual information is 15 ms or less; however, a vibrating motor using eccentric rotation has a slow response time ranging from 250 to 400 ms and a linear motor also has a slow response speed ranging from 50 to 70 ms, neither of which is sufficient to enable the user to feel synchronized vibration and which further do not enable the amount of vibration thereof to be adjusted.

### DISCLOSURE

### Technical Problem

Therefore, it is an object of the present invention to provide a vibrating mouse that enables a user to feel synchronized vibration by transmitting a haptic response due to vibration in synchronization with visual information to the user in real time.

### Technical Solution

In accordance with an aspect of the present invention, the above and other objects can be accomplished by the provision of a vibrating mouse providing a haptic feedback corresponding to visual information, the vibrating mouse including at least one actuator 4 mounted to an interior of a main body 2 of the vibrating mouse 1, the actuator 4 being constructed such that a piezoelectric vibrating body 6 is composed by integrally forming piezoelectric element layers 8 exhibiting a piezoelectric effect and an intermediate electrode plate 10 with each other, such that two opposite ends of the piezoelectric vibrating body 6 are fixed so as to generate vibration due to an up-and-down bending displacement, and such that weights 12 are attached to the piezoelectric vibrating body 6 in order to amplify vibration, whereby fast vibration, the amount of which is varied in a high frequency band, is generated in real time and is transmitted to a user as a haptic response corresponding to visual information at a high response speed, thereby providing the user with a realistic sensation.

### Advantageous Effects

According to the present invention, a mouse is equipped with an actuator to generate vibration, which has the effect of transmitting a haptic response in synchronization with visual information at a high response speed, consequently enabling a user to feel synchronized vibration.

Further, the amount of vibration of the actuator is adjusted or an eccentric vibrating motor is controlled to rotate in a low frequency band depending on the magnitude of vibration, which has the effect of providing various vibration patterns, for example, a strong vibration or a micro vibration.

### DESCRIPTION OF DRAWINGS

FIG. 1 is an exploded perspective view of a vibrating mouse according to an embodiment of the present invention;

FIGS. 2a and 2b are constitutional views of an actuator of the present invention;

FIG. 3 is a view showing the configuration of a vibration transmission member that is mounted to a grip unit of the present invention;

FIGS. 4a and 4b are views showing another exemplary actuator that is mounted to the vibrating mouse;

FIG. 5 is a view showing the configuration of a piezoelectric macro-fiber composite that is mounted to the grip unit of the present invention;

FIG. 6 is a view showing the configuration of a small-sized piezoelectric element that is mounted to a click unit of the present invention; and

FIG. 7 is a view showing the construction in which the piezoelectric macro-fiber composite is mounted to the click unit.

### BEST MODE

Hereinafter, preferred embodiments of the present invention will be described in detail with reference to the accompanying drawings.

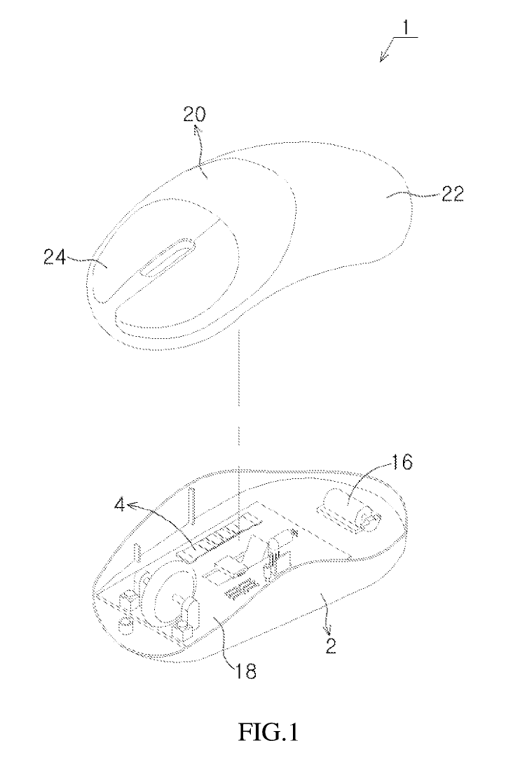

FIG. 1 is an exploded perspective view showing the construction of a vibrating mouse transmitting a haptic response in real time according to an embodiment of the present invention.

A vibrating mouse 1 of the present invention may be equipped with at least one actuator 4, which is mounted on or under a PCB 18 of a main body 2 or inside the vibrating mouse 1.

The actuator 4 may be embodied by the ‘piezoelectric vibrating device for mobile terminals’ disclosed in registered Patent No. 10-1366213 filed by this applicant; however, the configuration of the actuator 4 is not limited thereto, and piezoelectric vibrating devices having various configurations may be employed.

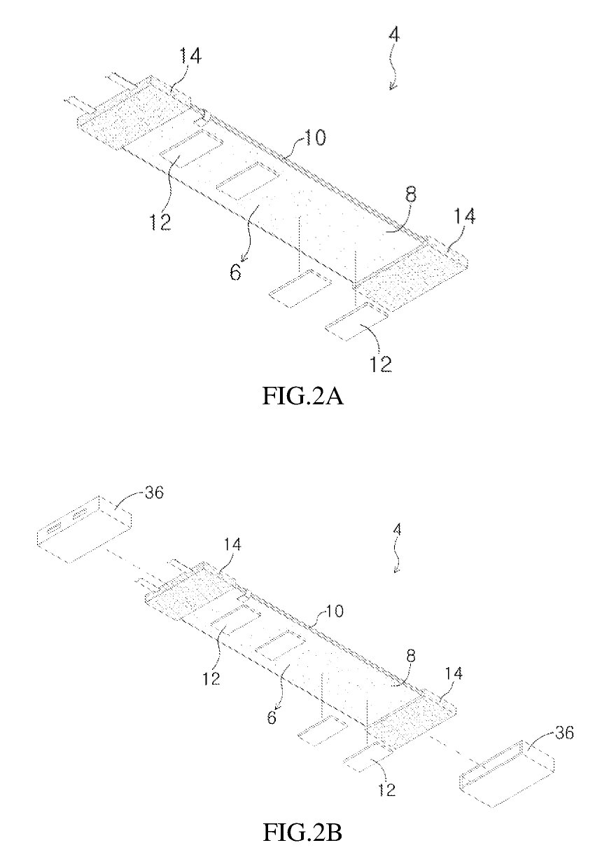

Describing briefly the configuration of the piezoelectric vibrating device for mobile terminals of the present invention shown in FIG. 2a, the actuator 4 is constructed such that a piezoelectric vibrating body 6 is composed by integrally forming piezoelectric element layers 8 and an intermediate electrode plate 10 with each other, such that two opposite ends of the piezoelectric vibrating body 6 are fixed so that it generates vibration due to an up-and-down bending displacement, and such that weights 12 are attached to the piezoelectric vibrating body 6 in order to amplify vibration.

The piezoelectric vibrating body 6 may be provided at the two opposite ends thereof with brackets 14 for assisting installation of the piezoelectric vibrating body 6, and the brackets 14 may also serve to prevent the leakage of electricity that is applied to the piezoelectric vibrating body 6.

Further, in the case in which the brackets 14 are made of a material having a high release property (for example, rubber, polyethylene or polypropylene), that is, a low attachability, as shown in FIG. 2b, separate fixing brackets 36 may be provided at the two opposite ends of the piezoelectric vibrating body 6, at which the brackets 14 are provided, so as to facilitate the installation of the piezoelectric vibrating body 6 to the interior of the vibrating mouse 1.

That is, the fixing brackets 36 made of a metal material are additionally provided at the two opposite ends of the piezoelectric vibrating body 6 and the two opposite ends of the actuator 4 are mounted to the interior of the vibrating mouse 1 by means of, for example, welding or an adhesive, with the result that the actuator 4 is securely mounted to the vibrating mouse 1 and the vibration generated by the actuator 4 is therefore effectively transmitted to the vibrating mouse 1.

The actuator 4 according to the embodiment of the present invention may be embodied as a vibrating device including any one of unimorph-type, bimorph-type, and multimorph-type piezoelectric elements.

Unlike a conventional linear motor, in which maximum vibration is achieved through resonance using a fixed frequency, the actuator 4 of the present invention is capable of generating vibration through variation of the frequency in a wide range due to the unique characteristics of the piezoelectric manner.

In addition, the piezoelectric-type actuator 4 has a high response speed and achieves adjustment of the frequency in a wide range, thereby minutely adjusting the magnitude and speed of the vibration and consequently enabling the user to feel delicate and synchronized vibration in accordance with a sound and an image.

In general, a piezoceramic actuator enables a real-time response with a response time of 5 ms or less, thereby making it possible for the user to feel synchronized vibration, and is controlled such that the amount of vibration varies in a wide frequency band (for example, from 0 to 300 Hz), thereby increasing realism due to the haptic response.

In the embodiment of the present invention, a vibrating motor 16 is further provided in association with the actuator 4 to generate vibration using eccentric rotation so as to provide the user with various vibration patterns in accordance with the amount of vibration.

In the present invention, when it is intended to transmit fast vibration, the amount of which is varied in a high frequency band, the vibration generated by the actuator 4 is provided, and when it is intended to transmit slow vibration in a low frequency band, the vibration generated by the vibrating motor 16, which has a low RPM and a large weight, is provided. For example, when it is intended to provide the user with micro vibration in association with soft background music, the actuator 4 may be used to provide the same even in the low frequency band, whereas when it is intended to provide slow and strong vibration in association with an engine sound, the vibrating motor 16 may be used to provide the same.

In accordance with the present invention, at least one actuator 4 may be mounted to the interior of the vibrating mouse 1, preferably on or under the PCB 18 in the main body 2, with the result that when the actuator 4 vibrates, the PCB also vibrates together with the actuator 4, exhibiting the effect of amplifying the vibration as if the entire vibrating mouse 1 were vibrating.

It is preferable for the vibrating motor 16 to be mounted to a region of the vibrating mouse 1 that is gripped by the user, that is, rear end regions of the main body 2 and a cover unit 20; however, if necessary, the vibrating motor 16 may be mounted to any other regions inside the vibrating mouse 1.

When the user grips the vibrating mouse 1 in the hand, the user's palm mostly comes into contact with the rear end region of the vibrating mouse 1, and accordingly, the vibrating motor 16 is mounted to the region that enables the user to perceive the vibration most favorably so as to transmit slow vibration to the entire area of the palm and to provide the user with a realistic sensation.

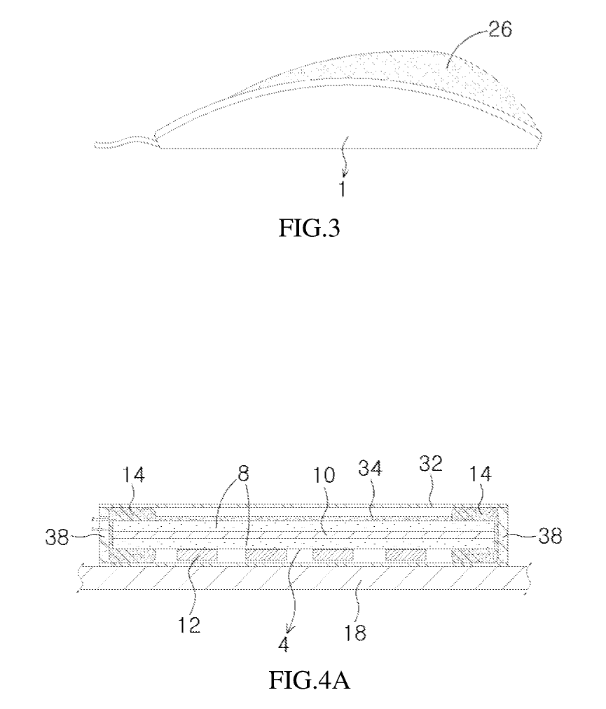

Further, as shown in FIG. 3, in the case in which the vibrating mouse 1 has a flat shape such that, when the user grips the vibrating mouse 1 in the hand, the center region of the palm cannot come into contact with the rear end region of the vibrating mouse 1 and the transmission of vibration is not facilitated, there may be further provided a vibration transmission member 26, which is mounted to the rear end region of the vibrating mouse 1 in an upwardly convex manner so as to increase the contact area with the palm and consequently to facilitate the transmission of vibration.

The vibration transmission member 26 may be securely adhered to the vibrating mouse 1 so as to perfectly transmit the vibration of the vibrating mouse 1 to the palm of the user.

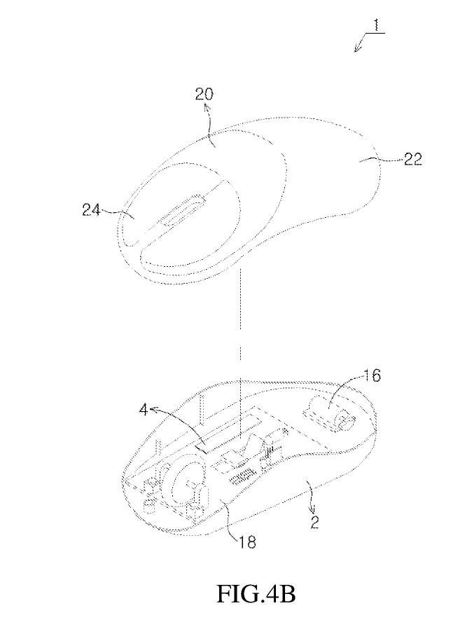

In accordance with the present invention, as shown in FIGS. 4a and 4b, it is possible to accommodate the actuator 4 in a casing 32 in a sealed manner and then to mount the casing 32 to the interior of the vibrating mouse 1.

As shown in FIG. 4a, the actuator 4 is fitted into an actuator-accommodating space formed in the casing 32, and the two opposite ends of the casing 32 are subjected to finishing treatment using sealing members 38.

The sealing members 38 serve as a soundproofing means that prevents a sound generated by the vibration of the actuator 4 from leaking outside and may be made of, for example, silicon, a UV adhesive, or epoxy.

In the state in which the actuator 4 is fitted in the casing 32, as shown in FIG. 4b, the casing 32 is attached to the interior of the vibrating mouse 1.

Undescribed reference numeral 34 denotes a protective tape that has the effects of preventing damage to the actuator 4 and insulating the actuator 4.

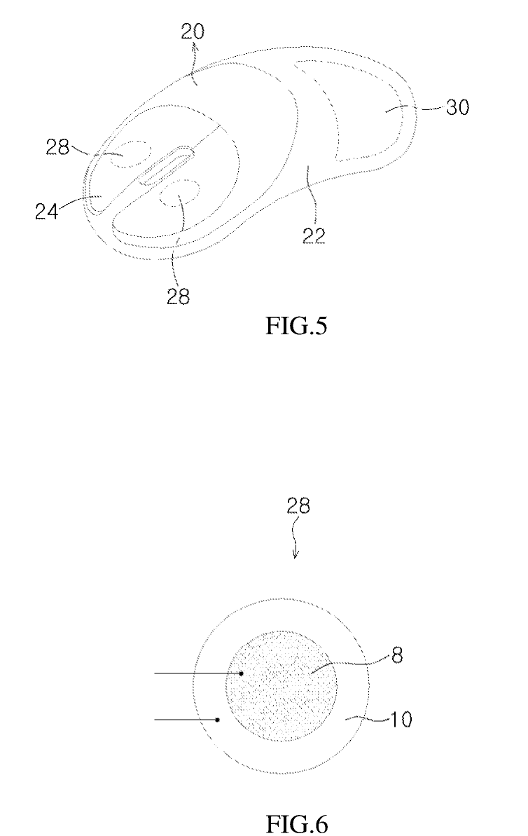

Described with reference to FIG. 5, the present invention may include a piezoelectric macro-fiber composite (MFC) 30, which is attached to a grip unit 22 in order to transmit a haptic response of the vibrating mouse 1 to the entire area of the palm.

The piezoelectric macro-fiber composite 30 is mounted to the interior of the grip unit 22, with which the most area of the palm of the user comes into contact when the user grips the vibrating mouse 1 and manipulates the same, so that the haptic response is evenly transmitted to the entire area of the palm, thereby increasing realism due to the vibration.

The piezoelectric macro-fiber composite 30 is formed in a flexible configuration by fiberizing a ceramic material in order to compensate for the weakness of the fragile ceramic material, whereby it can be easily mounted even to a round surface such as the grip unit 22.

In accordance with the present invention, it is possible to additionally use film-type polyvinylidene fluoride (PVDF) together with the piezoelectric macro-fiber composite 30.

The PVDF films may be attached to the grip unit 22 and click units 24 so as to transmit the haptic response to the palm and the fingertips of the user.

Described with reference to FIG. 6, the present invention may include circular-shaped piezoelectric ceramic units 28, which are mounted to the left and right click units 24 of the vibrating mouse 1, in order to provide the manipulation feeling due to the vibration when the user manipulates the left and right click units 24 of the vibrating mouse 1 with the fingers.

The piezoelectric ceramic units 28 may be mounted under the click units 24, that is, to the interior of the vibrating mouse 1, and may be formed in a compact size that is capable of transmitting vibration to the fingers when the click units 24 are pressed.

Specifically, when the click units 24 are pressed, for example, during a game, and a predetermined condition is satisfied, vibration is transmitted to the fingertips, thereby increasing reality of the game.

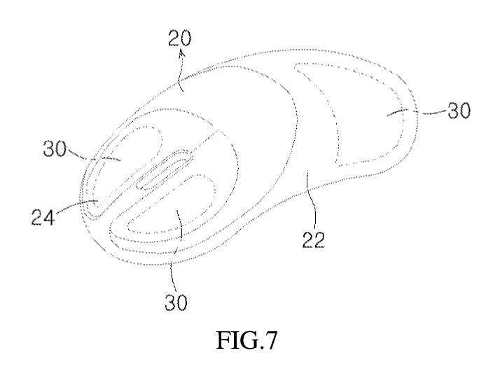

As shown in FIG. 7, the piezoelectric macro-fiber composite 30 may be mounted to the click units 24, and at this time, the piezoelectric macro-fiber composite 30 may be attached to any one of the inner surface and the outer surface of each of the click units 24.

As described above, since the piezoelectric macro-fiber composite 30 is formed in a flexible configuration, it can be easily mounted to the click units 24, which take the form of round surfaces. When the piezoelectric macro-fiber composite 30 is mounted to the outer surface of each of the click units 24, a separate film may be attached to the top surface of the piezoelectric macro-fiber composite 30, which has been mounted to the outer surface of each of the click units 24.

The attachment of the piezoelectric macro-fiber composite 30 to the outer surfaces of the click units 24 may enable vibration to be directly transmitted to the fingers and consequently may make it possible to feel a more realistic haptic response.

As described above, the vibrating mouse 1 according to the present invention is equipped with the actuator 4 to generate vibration, thereby transmitting a haptic response in synchronization with visual information at a high response speed and consequently enabling the user to feel synchronized vibration.

Further, the amount of vibration of the actuator 4 is adjusted or the eccentric vibrating motor 16 is controlled to rotate in a low frequency band depending on the magnitude of vibration, which has the effect of providing various vibration patterns, for example, a strong vibration or a micro vibration.

Although the present invention has been described with reference to the preferred embodiments, various modifications can be made without departing from the scope of the invention. Therefore, the scope of the invention is not limited to the above embodiments and should be defined only by the accompanying claims and equivalents thereof.

### INDUSTRIAL APPLICABILITY

The present invention is applicable to electronic devices, for example, a vibrating mouse or a smart remote controller, which provide a user with a haptic response at a high response speed so as to enable the user to feel synchronized vibration.

1. A vibrating mouse providing a real-time haptic feedback corresponding to visual information, comprising:
at least one actuator mounted to an interior of a main body of the vibrating mouse, the actuator being constructed such that a piezoelectric vibrating body is composed by integrally forming piezoelectric element layers exhibiting a piezoelectric effect and an intermediate electrode plate with each other, such that two opposite ends of the piezoelectric vibrating body are fixed so as to generate vibration due to an up-and-down bending displacement, and such that weights are attached to the piezoelectric vibrating body in order to amplify vibration, whereby fast vibration, the amount of which is varied in a high frequency band, is generated in real time and is transmitted to a user as a haptic response corresponding to visual information at a high response speed, thereby providing the user with a realistic sensation.

2. A vibrating mouse providing a real-time haptic feedback corresponding to visual information, comprising:
at least one actuator mounted to an interior of a main body of the vibrating mouse, the actuator being constructed such that a piezoelectric vibrating body is composed by integrally forming piezoelectric element layers exhibiting a piezoelectric effect and an intermediate electrode plate with each other, such that two opposite ends of the piezoelectric vibrating body are fixed so as to generate vibration due to an up-and-down bending displacement, and such that weights are attached to the piezoelectric vibrating body in order to amplify vibration, whereby fast vibration, the amount of which is varied in a high frequency band, is generated in real time; and
a vibrating motor mounted to a rear end region of the main body, the vibrating motor being configured to generate vibration due to shaking generated by eccentric rotation of the motor in order to transmit slow vibration in a low frequency band, whereby vibration, the amount of which is varied corresponding to visual information, is transmitted to a user as a haptic response at a high response speed, thereby providing the user with a realistic sensation.

3. The vibrating mouse providing a real-time haptic feedback according to claim 1, further comprising:
a piezoelectric macro-fiber composite having a flexible configuration and mounted to a grip unit of the vibrating mouse in order to transmit vibration to an entire area of a palm that is gripping the mouse.

5. The vibrating mouse providing a real-time haptic feedback according to claim 1, further comprising:
a vibration transmission member mounted to a grip unit of the vibrating mouse in order to facilitate close contact with a palm.

6. The vibrating mouse providing a real-time haptic feedback according to claim 1, further comprising:
a piezoelectric ceramic unit mounted to a click unit of the vibrating mouse in order to provide a manipulation feeling due to the vibration via a finger when the user clicks the vibrating mouse.

7. The vibrating mouse providing a real-time haptic feedback according to claim 1, further comprising:
a piezoelectric macro-fiber composite mounted to a click unit of the vibrating mouse in order to provide a manipulation feeling due to the vibration via a finger when the user clicks the vibrating mouse.

8. The vibrating mouse providing a real-time haptic feedback according to claim 1, wherein the actuator is a vibrating device including any one of unimorph-type, bimorph-type, and multimorph-type piezoelectric elements.

9. The vibrating mouse providing a real-time haptic feedback according to claim 1, further comprising:
a casing for assisting installation of the actuator to the interior of the vibrating mouse, the casing accommodating the actuator fitted therein and having two opposite ends that are subjected to finishing treatment using sealing members.

10. The vibrating mouse providing a real-time haptic feedback according to claim 1, wherein the piezoelectric vibrating body is provided at two opposite ends thereof with brackets for assisting installation of the piezoelectric vibrating body.

11. The vibrating mouse providing a real-time haptic feedback according to claim 10, wherein the piezoelectric vibrating body is provided at the two opposite ends thereof, at which the brackets are provided, with fixing brackets made of a metal material in order to firmly secure the actuator to the interior of the vibrating mouse.

12. The vibrating mouse providing a real-time haptic feedback according to claim 2, further comprising:
a piezoelectric macro-fiber composite having a flexible configuration and mounted to a grip unit of the vibrating mouse in order to transmit vibration to an entire area of a palm that is gripping the mouse.

13. The vibrating mouse providing a real-time haptic feedback according to claim 12, further comprising:
PVDF films mounted to the grip unit and a click unit of the vibrating mouse in order to transmit the haptic response to the palm and a fingertip that are gripping the mouse.

14. The vibrating mouse providing a real-time haptic feedback according to claim 2, further comprising:
a vibration transmission member mounted to a grip unit of the vibrating mouse in order to facilitate close contact with a palm.

15. The vibrating mouse providing a real-time haptic feedback according to claim 2, further comprising:
a piezoelectric ceramic unit mounted to a click unit of the vibrating mouse in order to provide a manipulation feeling due to the vibration via a finger when the user clicks the vibrating mouse.

16. The vibrating mouse providing a real-time haptic feedback according to claim 2, further comprising:
a piezoelectric macro-fiber composite mounted to a click unit of the vibrating mouse in order to provide a manipulation feeling due to the vibration via a finger when the user clicks the vibrating mouse.

17. The vibrating mouse providing a real-time haptic feedback according to claim 2, wherein the actuator is a vibrating device including any one of unimorph-type, bimorph-type, and multimorph-type piezoelectric elements.

18. The vibrating mouse providing a real-time haptic feedback according to claim 2, further comprising:
a casing for assisting installation of the actuator to the interior of the vibrating mouse, the casing accommodating the actuator fitted therein and having two opposite ends that are subjected to finishing treatment using sealing members.

19. The vibrating mouse providing a real-time haptic feedback according to claim 2, wherein the piezoelectric vibrating body is provided at two opposite ends thereof with brackets for assisting installation of the piezoelectric vibrating body.

20. The vibrating mouse providing a real-time haptic feedback according to claim 19, wherein the piezoelectric vibrating body is provided at the two opposite ends thereof, at which the brackets are provided, with fixing brackets made of a metal material in order to firmly secure the actuator to the interior of the vibrating mouse.
